(19) United States
(12) Patent Application Publication
(10) Pub. No.: US 2023/0316178 A1
(43) Pub. Date: Oct. 5, 2023

(54) SYSTEM FOR SYNCHRONIZING CONTEXTUAL NOTIFICATIONS FOR EVENT FEED ITEMS

(71) Applicants: Atlassian Pty Ltd., Sydney (AU); Atlassian Inc., San Francisco, CA (US)

(72) Inventor: David Wilson, Sydney (AU)

(21) Appl. No.: 17/708,109

(22) Filed: Mar. 30, 2022

(51) Int. Cl. G06Q 10/06; G06F 9/451

(52) U.S. Cl. CPC G06Q 10/063114; G06F 9/451

(57) ABSTRACT

Embodiments are directed to methods for coordinating updates at an issue tracking system. The methods can include obtaining a user identification associated with the mobile device and obtaining a list of issues associated with the user identification. The methods can include displaying issues on the issue summary board and, for each issue of the subset of issues, querying an update service to obtain update information. The method may include rendering a set of cards, each associated with a respective issue, and causing display of the cards on the issue summary board where the cards each include the issue data and the update summary. In response to a user selecting a particular card, issue data for the selected card can be displayed and a view flag can be modified to indicate that the updates summary for the card has been viewed.

### FIELD

The described embodiments relate to event feeds that may be displayed in a user interface and, in particular, to systems and methods for rendering event feed items in an event feed having update indicia that are synchronized with user view events of corresponding content items.

### BACKGROUND

Organizations are increasingly using various software products to facilitate communication and workflow between individuals and teams. In many cases, these software products will have both desktop and mobile versions. The desktop version may include a user interface and interaction scheme that is different from the mobile application. For example, the desktop version of a software product may include more detailed user interfaces, a greater selection of tools, etc. due to the larger size of most desktop displays. The mobile version of the product may allow a user to view summaries or other higher level details on projects hosted by the software product. In many cases, an important function of the mobile version may be to provide a user with updates, alerts, or other notifications for one or more projects. The systems and techniques described herein help to ensure the accuracy of the information that is displayed on the limited area available in some event feed graphical elements.

### SUMMARY

Embodiments are directed to methods for coordinating updates at an issue tracking system. The method can include obtaining a user identification associated with the mobile device and obtaining a list of issues associated with the user identification in response to a request to view an issue summary board from a mobile device. The method can also include identifying a subset of issues for display on the issue summary board and, for each issue of the subset of issues, querying an update service to obtain update information if available. The method may include rendering a set of cards, where each card is associated with a respective issue of the subset of issues. The rendering the set of cards can include, for each card obtaining issue data regarding the respective issue associated with the card, in response to update information being available for the respective issue and a view flag indicating that the issue has not been viewed, generate an update summary and cause display of the card on the issue summary board where the card includes the issue data and the update summary. The method can further include, in response to a user selecting a particular card of cards displayed on the issue summary board, causing the display of the issue data for the respective issue associated with the particular card and modifying the view flag to indicate that the update summary for the particular issue has been viewed. In response to a request to view the particular issue subsequent to modifying the view flag, the method can include causing the display of issue data of the particular issue within the card and updating the display of the update summary associated with the particular issue in accordance with the view flag.

Embodiments are also directed to computer-implemented methods for synchronizing update notifications for feed items of an issue tracking system. The methods include obtaining a user identification associated with the request and obtaining a list of issues associated with the user identification in response to a request to view an issue summary board on a mobile device. The methods can include identifying a subset of issues for display on the issue summary board and for each issue of the subset of issues, querying an update service for update information and rendering a set of cards, each card associated with a respective issue of the subset of issues. The rendering the set of cards can include, for each card, obtaining issue data regarding the respective issue associated with the card, generate an update summary in accordance with update information being available for the respective issue and a view flag indicating that the issue has not been viewed, and causing display of the card on the issue summary board. The card can include at least a portion of the issue data and the update summary. The methods can include causing the display of the issue data for the respective issue associated with the particular card in response to a user selecting a particular card of list of cards displayed on the issue summary board. The issue data can include an indication for each new update associated with an issue corresponding to the card. In response to a user selecting an update, the methods can include modifying a view flag corresponding to the selected update to indicate that the update for the for the issue has been viewed. In response to a request to view the particular care subsequent to modifying the view flag, the methods can include updating the display of the update summary associated with the particular issue in accordance with the view flag.

Embodiments are also directed to computer-implemented methods for synchronizing update notifications for feed items of an issue tracking system. The methods can include obtaining a user identification associated with the request and obtaining a list of issues associated with the user identification in response to a request to view a first issue summary board on a mobile device. The methods can include identifying a subset of issues for display on the first issue summary board and for each issue of the subset of issues, querying an update service for update information, rendering a first set of cards, each card associated with a respective issue of the subset of issues. The rendering the set of cards can include, for each card, obtaining issue data regarding the respective issue associated with a card, generating an update summary in accordance with the update information being available for the respective issue and a view flag indicating that an issue has not been viewed, and causing display of the card on the first issue summary board, the card comprising at least a portion of the issue data and the update summary. The methods can include, in response to a user selecting a particular card of a list of cards displayed on the issue summary board, modifying the view flag to indicate that the update summary for a particular issue has been viewed. In response to a request to view a second issue summary board associated with the user account on a desktop device subsequent to modifying the view flag the methods can include causing the display of a second set of cards on the second issue summary board, the second set of cards comprising the particular card and updating the display of the update summary associated with the particular issue in accordance with the view flag.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 shows an example networked computer system in which various features of the present disclosure may be implemented;

FIG. 2 shows an example of a home screen displayed in a graphical user interface of a mobile issue tracking application;

FIG. 3 shows an example of a project feed displayed in a graphical user interface of a mobile issue tracking application;

FIGS. 4A-4B show examples of issue data displayed in graphical user interfaces of a mobile issue tracking application;

FIG. 5 shows an example process for displaying updates on a mobile application for issues managed by an issue tracking system;

FIG. 6 shows an example process for synchronizing updates across different application platforms of an issue tracking system;

FIG. 7 shows an example issue service queue displayed in a graphical user interface of a mobile issue tracking application; and

FIG. 8 shows a sample electrical block diagram of an electronic device that may perform the operations described herein.

While the invention as claimed is amenable to various modifications and alternative forms, specific embodiments are shown by way of example in the drawings and are described in detail. It should be understood that the drawings and detailed description are not intended to limit the invention to the particular form disclosed. The intention is to cover all modifications, equivalents, and alternatives falling within the scope of the present invention as defined by the appended claims.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

Embodiments disclosed herein are directed to systems and methods for providing accurate contextual updates to a user's issue feed across multiple software applications and computer environments. In general, an issue feed may display feed items relating to issue tickets in an issue tracking system and different application platforms may display issue feeds differently. For example, the appearance and/or content of a user's issued feed, including what feed items are shown, may differ based on the particular application platform. If a user is engaging with a graphical user interface (GUI) of a mobile application, the issue feed may show a first list or set of graphical summaries that each correspond to an issue associated with the user. As used herein graphical summaries relating to an issue may be referred to as a “card,” an “issue card,” a “tile,” or other similar graphical element. Each issue card may include information such as a title and/or other identification of a particular issue, a user(s) associated with the issue, an indication of new updates to the issue or any other suitable information about the issue. If a user is engaging with a GUI of a desktop application, the issue feed may show a different set of issues, display issue cards with a different layout and/or with different information than the mobile application, and so on.

Generally, the issue tracking system described and referenced herein, may generate a ticket or issue number for each issue that is entered into the system. The ticket or issue number can be used to track the issue as it is worked on by one or more users of the system. An issue may be associated with a workflow that defines steps that will be taken to address the issue and/or other tasks that need to be completed in order to address an issue. Different steps and/or tasks may be assigned to different users of the issue tracking system. In some cases, a project manager may be assigned to an issue to track progress on an issue, determine which tasks are needed, and track completing of the various steps and/or tasks assigned to an issue. The issue tracking system may generate events, which are aggregated and displayed in an issue feed that can be adapted for each user of the system. An issue feed for a project manager may show a set of issue cards for issues that are being managed by the project manager. An issue feed for a developer or other user may show a different set of issue cards for issues that are associated with that user. Accordingly, each issue feed may be unique to a particular user.

Content for the various issues that are being tracked is updated on a continuous basis and the system described herein can be used to provide contextual alerts for updated content. For example, as issues are updated (or other changes occur to a particular issue), the system may receive a notification that an update has occurred. The system can use an event feed to alert the user of an update using a notification feed that aggregates a list of all updates that have occurred to issues associated with a particular user. The feed may include an update summary or other indicia that an update has occurred. The system described herein is directed to techniques for accurately tracking updates and ensuring that update summaries are synchronized with a viewing history for a particular user.

As described herein, the methods and system described herein provide update summaries to a user within the context of the associated issue, for example, within an issue card displayed on an issue summary feed. Accordingly, when viewing an issue feed board, issue cards may include an update summary indicating that one or more updates have occurred to a corresponding issue. For example, the update summary may include a visual indication that new updates (e.g., 2 new updates) have occurred to the corresponding issue. A user may be able to select the issue card to view additional details about the issue and/or the updates. For example, selecting the issue card may cause the mobile application to display issue data, which may include a priority for the issue, reminders, information about linked issues, diagrams, issue summaries, recent activity, or any other suitable information about the issue. In some cases, when the issue card indicates that there are new updates, in response to a user selecting the card, the issue tracking system may indicate which issue data has been updated, for example by providing a summary at the top of the display and/or distinguishing the issue data that has been updated.

In some cases, the system may track updates to each issue using an update variable such as an view flag. The system may associate different updates, to the same issue or different issues, with a unique view flag. The system may not clear an view flag until a defined type of interaction has occurred. For example, the user may need to interact with/acknowledge a particular update before an view flag is cleared or modified. In some cases, this can include a user first selecting a particular issued card that has one or more updates (indicated by an updates summary) and subsequently selecting, viewing, or interacting with the updated issue details that are displayed in the issue data. This may reduce the occurrence of a user inadvertently clearing an update summary/view flag for an issue.

In some cases, an issue may include multiple updates, which can be indicated on an issued card (e.g., “2 new updates”) displayed on an issue feed. A user may select the issue card to view the corresponding issue details. The system may cause the mobile application to display an indication of each update in the issue details view. For example, at the top of the issue details view, the system may cause the mobile application to display a summary line for each update that, when selected by a user, causes the mobile application to display at least a portion of the issue details associated with the selected summary. If a user only selects one of the summary lines, the view flag for the corresponding summary line may be updated to indicate that the corresponding update has been viewed, while the view flag for the other, unselected update is maintained. The corresponding update summary for the issue card may be updated and the issue details view may be updated in accordance with these view flags. Accordingly, in this example, the update summary of the issue card may indicate that there is only one update to the corresponding issue and the system update may also update the issue details view to only show one update.

Additionally or alternatively, changes to view flags can be applied to hierarchical related issues and/or content items. For example, if a view flag is updated to indicate that a new update has been viewed, which may result in a summary on an issue card changing, a project summary card (e.g., higher hierarchical level card) may be updated to reflect this change.

In some cases, updates can be managed in different ways. For example, updates can be associated with a user group, and one (or a subset of users) viewing an issue may cause a new update to be cleared for all users associated with the group. For example, if a manager views (or otherwise interacts with) a new update, the system can cause the new update to be cleared for all or a subset of users associated with that issue.

The embodiments are described herein in the context of an issue tracking system. However, the same principles, method, and techniques can be applied to other types of application environments including collaborative documents systems, code repositories, messaging systems, and so on. For example, if a user is engaging with a GUI of a collaborative document system, an event feed may show feed items relating to documents in the collaborative document system and the feed items can include updates summaries that indicate whether an update has been made to a corresponding document. Selecting a particular feed item (e.g., document card) may result in a document data to be displayed and one or more indications as to which portions of the document and/or document data have been updated. In some cases, the update summary and/or view flags for updates may not be cleared until some threshold interaction has occurred with the updated portion of the document.

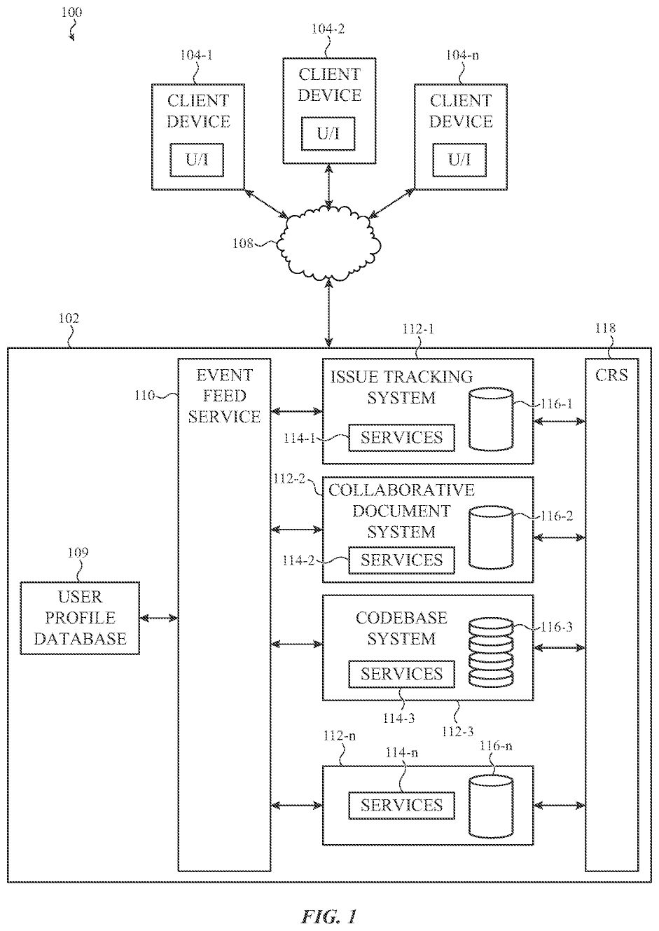

These and other embodiments are discussed below with reference to FIGS. 1-8. However, those skilled in the art will readily appreciate that the detailed description given herein with respect to these Figures is for explanatory purposes only and should not be construed as limiting.

FIG. 1 shows an example networked computer system 100 (also referred to as “system 100”) in which various features of the present disclosure may be implemented. The system 100 includes an application platform 102 and client devices 104 (104-1, . . . , 104-n) that communicate via a network 108 (e.g., the Internet). The client devices 104 may be any suitable type of device, including but not limited to a desktop or laptop computer, tablet computer, mobile phone, personal digital assistant, smart device, voice-based digital assistant, or the like.

The application platform 102 may be or may include one or more servers, content stores (e.g., databases), communications systems, data structures, programs, or other components, systems, or subsystems that provide services described herein, including event feed services. The application platform 102 may include an event feed service 110, one or more software applications 112 (e.g., 112-1, . . . , 112n), a user profile database 109, and a content update service 118. The one or more software applications 112 provide content and content services to users of the system 100, as described herein. The event feed service 110 may generate event feeds, and may send and receive information relating to the event feeds among the software applications 112 and client devices 104 of the system 100.

The software applications 112 may include application services 114 (e.g., 114-1, . . . , 114-n) and data stores 116 (e.g., 116-1, . . . , 116-n). Application services 114 may facilitate the creation, deletion, management, editing, serving, and/or other services related to the issues, content, and/or content items associated with that software application and stored in the data store 116. The application services 114 may also generate events or messages in response to changes or activity occurring with respect to the various software applications 112. Data stores 116 may be databases or other data storage resources that store content items and/or other data related to a software application 112. The software applications 112 may be associated with dedicated servers or server systems. The software applications 112 may also be implemented using a software as a service (SaaS) architecture which may be accessed by a client device 104 via a web browser or other similar client application.

In some cases, a first software application 112-1 may be an issue tracking system that tracks issues or discrete aspects of a development project or other process using tickets or an issue number. Information related to the various issues (referred to herein as “issue data”) may be stored in a respective data store 116-1. In general, issues are tracked along a workflow or set of issue states from initiation to resolution. Issue data may include various content including, for example, a user-generated description of an issue, issue status (e.g., closed, open, awaiting review), assignee, supervisor or reviewer, related user, issue urgency, issue age or pendency, images, links to code, and other issue-related content. In some cases, issue data may include user-generated specifications of issues in computer code of software products. Issue data may be stored in the data store 116-1 as files, data structures, or the like.

The application services 114-1 of the issue tracking system may facilitate content services related to the issues, including causing user interfaces of the issue tracking system to be displayed to a user on a client device 104, receiving user inputs relating to the creation and/or modification of issues (e.g., changing status, receiving content related to the issue and/or issue resolution, etc.), changes to issue status, changes to user assignments, and the like. The application services 114-1 may also send to the event feed service 110 event notifications or other communications related to events caused by activity related to the various issues being tracked by the issue tracking system 112-1.

A second software application 112-2 may be a collaborative document system. The collaborative document system may allow users (e.g., via client devices 104) to create, modify, view, and/or otherwise interact with documents, which may be stored in the data store 116-2. Documents may be user-generated, and may include content such as text, images, graphics, tables, or the like. Documents may be linked or otherwise related to one another in a document hierarchy. Documents (e.g., user-generated documents) may be stored in the data store 116-2 as files, data structures, or the like.

The application services 114-2 of the collaborative document system may facilitate content services related to the documents, including causing user interfaces of the collaborative document system to be displayed to a user on a client device 104, receiving user inputs relating to the creation and/or modification of documents, and the like. The application services 114-2 may also send to the event feed service 110 notifications, messages, or other communications regarding events generated in response to activity related to user-generated documents stored in the data store 116-2 or otherwise managed by the collaborative document system 112-2.

A third software application 112-3 may be a codebase system that provides services related to creating, developing, maintaining, and/or deploying software code. Software code may be stored in codebases 116-3. In some cases, code for distinct software programs, environments, platforms, or the like, may be stored in or as distinct codebases 116-3. Distinct codebases may be stored in different databases or data stores, or they may share one or more databases or data stores. Similar to the other systems described above, the codebase system may transmit messages or notifications regarding events (commits, pulls, deployments, etc.) that reflect activity managed by the codebase system 112-3.

The software applications 112 may communicate with a content update service (CUS) 118. The content update service 118 may monitor, track, analyze, and/or store information about relationships between and among content items and users of the application platform 102. For example, the CUS 118 may monitor for and/or maintain information about which users have accessed, created, modified, commented on, viewed, or otherwise interacted with which content items in the application platform 102. Further, the CUS 118 may monitor for and/or maintain information about links between content items in the application platform 102. The CUS 118 may analyze the information to determine links between content items, user generated documents, users, teams, projects, issues, issue tickets, codebases, and/or other entities of the application platform 102. The CUS 118 may monitor information in real time (e.g., in direct response to and shortly following the actions generating the information) or may obtain information from user event logs, transaction logs, or other similar data stores created in response to user interactions with the software applications. While the event feed service 110 and the CUS 118 are depicted as two separate services, they may be combined as a single service performed on shared hardware and/or by the same composite services.

The event feed service 110 communicates with the software applications 112 and/or CUS 118 to receive notifications of events (and optionally content associated with the events). The notifications of events may be provided to the event feed service 110 according to a push protocol in which the software applications 112 send the notifications according to their own schedule (e.g., in response to an event occurring and generating a notification), or according to a fetch or pull protocol in which the event feed service 110 requests or pulls notifications of events from the software applications 112.

The event feed service 110 may generate event feed items (or simply feed items) and event feeds for users based on the received notifications, and send and/or provide the event feeds to client devices 104 for display to users. For example, the event feed service 110 may receive a notification of a modification to a document in an issue tracking service (e.g., the software application 112-1), and generate a feed item based on the notification. The feed item may include information about an issue and one or more actionable input objects that a user can interact with to cause a change or modification to the issue. The feed item may be displayed to a user (e.g., on a client device 104) in a manner that is customized based on factors such as the identity of the user, the software application in which the event feed is displayed, feed presentation preferences of the user, or the like. The event feed service 110 may generate feed items and send the feed items to the client devices 104 for display in an event feed. In some cases, the event feed service 110 generates definitions of feed items, where the definitions include an address of the underlying content item to which the feed item relates. The definition, when sent to a client device 104, may cause the client device 104 to retrieve the content item or information from the content item.

The event feed service 110 may store and manage subscriptions of users to feed item sources. For example, for each user for which the event feed service 110 generates event feeds, the event feed service 110 may maintain a list of feed item sources to which that user subscribes (e.g., follows). When events occur with respect to those feed item sources (e.g., when notifications are received from or associated with a feed item source), the event feed service 110 may generate feed items based on those notifications, and include those feed items in the event feeds of users who have subscribed to the feed item source.

As used herein, a user subscribing to or following a feed item source may result in the user receiving feed items in their event feed related to the feed item source. Subscriptions may be stored and/or managed by the event feed service 110 as described herein. Subscribing to or following a feed item may result in all events associated with the feed item source being included in an event feed to the subscribed user, or only a subset of the events associated with the feed item source. A subscription to content such as a document may result in events that occur with respect to that content (e.g., edits, comments, changes in status, etc.) being included in the event feed of a subscribed user. A subscription to a user may result in events that occur with respect to the user being included in the event feed of a subscribed user. More particularly, any activity or action of or associated with a user with respect to content or other entities in the networked computer system 100 may be the subject of a feed item in a subscribed user's event feed. For example, a first user may have many different interactions with content in a networked computer system 100. When a second user subscribes to a first user, the activities of the first user in the networked computer system 100 may initiate feed items in the event feed of the second user, even across multiple content items, types of content, etc. Thus, for example, if the first user comments on a document, changes a status of an issue ticket, or becomes a member of a project or team, each of those events may cause a corresponding feed item to be generated and displayed to the second user.

The event feed service 110 may also receive, from client devices 104, information about interactions with the feed items. For example, if a user interacts with an actionable input object of a feed item, information about that interaction may be sent from a client device 104 to the event feed service 110, which may then communicate that information to the relevant software application 112. As one nonlimiting example, if a user interacts with a feed item relating to an issue ticket and assigns the issue ticket to another user, the event feed service 110 may receive the information (e.g., an identifier of the issue ticket and an identifier of the new user), and provide that information to the event feed service 110 so that the underlying content item (e.g., the issue ticket) can be modified appropriately. In some cases, the event feed service 110 communicates interactions to the CUS 118, which may be recorded as part of the activity feed for any related content (issues, documents, code, etc.).

While collaborative document systems, issue tracking systems, and codebase systems are used as example software applications, these are merely examples of software applications that may be used with event feed services described herein. Other types of software applications and/or content sources that may provide feed items and about which feed item source recommendations may be generated include, without limitation, messaging applications (e.g., instant message applications, email applications, group-messaging applications, etc.), wiki applications, sales management applications, project management applications, human resources applications, or the like.

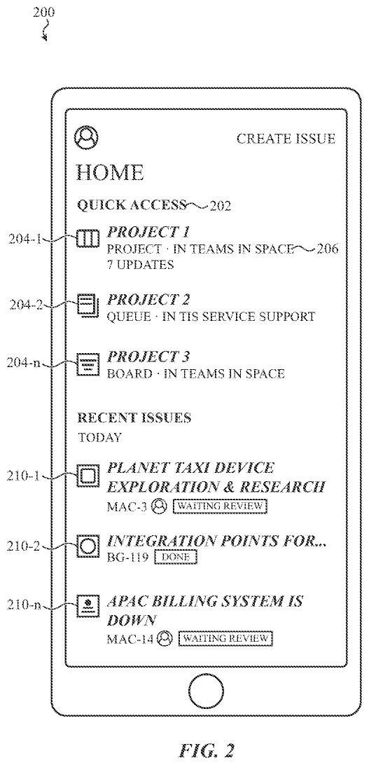

FIG. 2 shows an example of a home screen 200 displayed in a graphical user interface of a mobile issue tracking application, which may be a dedicated application, a mobile web browser, or other type of application. The home screen 200 may be displayed upon the issue tracking system being opened on a mobile device and includes a first set of menu options that allows a user to navigate to different projects, issues, or initiate other functions of the issue tracking application. The home screen 200 may also be displayed in response to navigation to a home uniform resource locator (URL) or other similar network address.

In some cases, the home screen 200 can include a quick access section 202, which may contain a list of cards that relate projects associated with a particular user. For example, the quick access section 202 or tab may include a summary card 204 (e.g., 204-1, . . . , 204-n) for each project that is associated with a user of the mobile device (e.g., user that is logged into the issue tracking application). Each card 204 may be generated in response to, or updated in response to, event notifications received by an event feed service (e.g., feed event service 110 of FIG. 1). Each project may be associated with a set of issues that need to be addressed and each issue may have various items that need to be addressed by different users or groups of users of the system. As updates are made to an issue, the system (e.g., CUS 118 of FIG. 1) may track updates that are made to each issue and determine whether those updates have been viewed by a particular user.

The system may display an update summary 206 that indicates whether new updates have been made to a project, which may include updates to issues associated with a project. In some cases, the update summary 206 may indicate that there are new updates without providing any additional details. In other cases, the update summary 206 includes an update indicia that may indicate a number of new updates (if there are multiple updates) and/or other information related to the updates such as when the new updates occurred (e.g., updates in the last 24 hours).

In some cases, the home screen 200 may include recent issue feed 208, which may contain a list of cards 210 that may reflect recent activity and/or items that are waiting input from the user. For example, the issue feed 208 can include a list of the most recent updates to issues corresponding to issue cards 210 (e.g., 210-1 . . . 210-n) associated with the user. For example, a first issue card in the issue feed 208 may correspond to the first update, request for review or other input for a user made within a specific time frame, and each subsequent issue card 210-2 to 210-n may correspond to a next update and/or request made within that time period.

Accordingly, the recent issue feed 208 may display a chronological list of issue cards that require input from the user for a given time period. In other cases, the recent issue feed 208 may arrange the issue cards 210 according to an assigned priority. For example, issue cards 210 with the highest priority are displayed higher in the recent issue feed 208. Additionally or alternatively, the recent issue feed 208 may display issues based on a combination of factors, for example, issue cards 210 may be displayed based on a combination of a priority and how long they have been pending. In some cases, this may allow the recent issue feed 208 to display higher priority and longer pending issues at the top of the list.

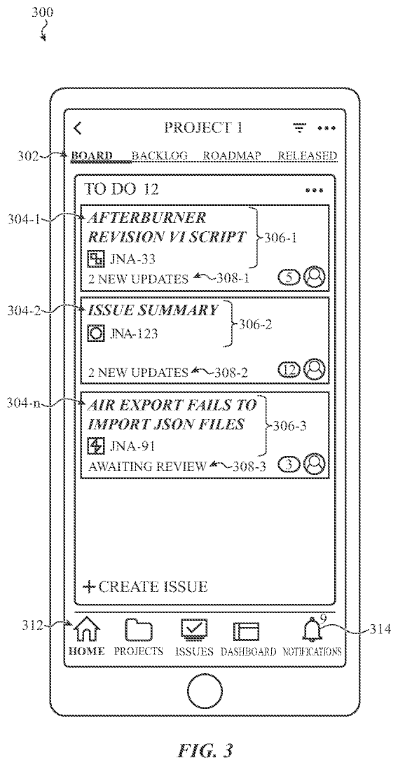

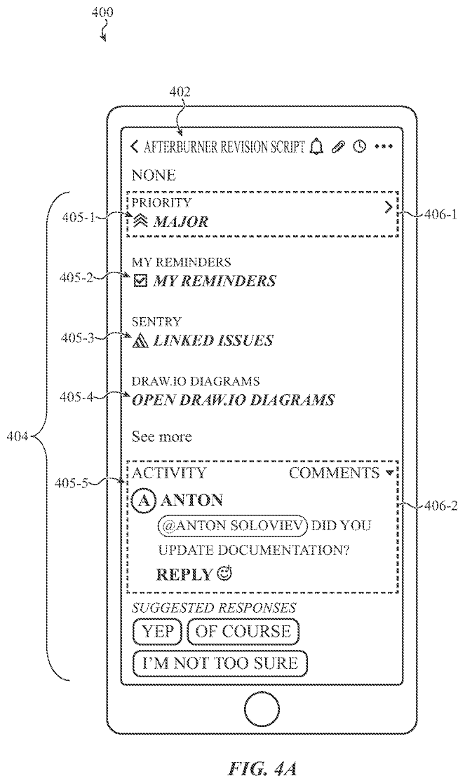

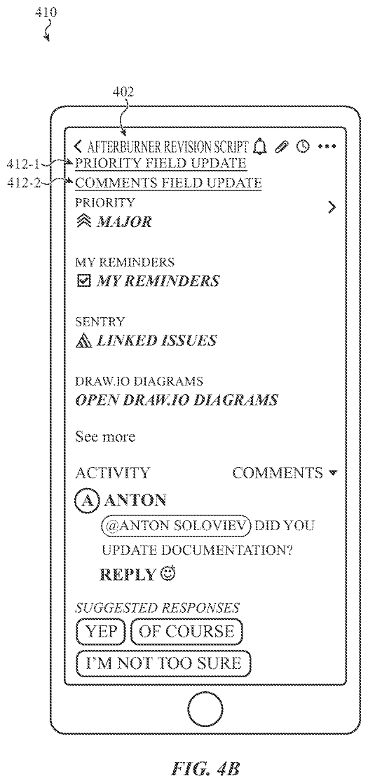

A user input or selection of a project summary card 204 from the quick access section 202 may result in the display of a feed board, which can display a list of issues and/or other content items associated with the selected project. For example, selecting the Project 1 204-1 from the quick access section 202 may display a feed board such as shown in FIG. 3. In some cases, selecting an issue 210 from the recent issues feed 208 may open an issue summary for the selected issue. For example, selecting the first issue 210-1 may display an issue summary page such as shown in FIG. 4A.

FIG. 3 shows an example of a project feed 300 displayed in a graphical user interface of a mobile issue tracking application. The project feed 300 can include a variety of options for displaying issue cards or other items associated with a particular project. In the illustrated example, an issue feed board 302 is selected, which displays a list of issue cards associated with a project and a particular user account. In other cases, the project feed 300 can display issues or other content items associated with a project according to other organizational schemes and/or content layouts. For example, selecting the “Backlog” tab may cause the system to display a list of items or issue cards that have been pending longer than a predetermined amount of time. Selecting a “Roadmap” tab may cause the system to display a list of issue cards selected in accordance with a roadmap or scheduled workflow, which may organize the issues according to one or more dependencies.

The issue feed board 302 may display a set of issue cards 304 that includes information about issues associated with a user account. Each card 304 can include issue data 306 and an update summary 308. The issue data 306 can include information about a particular issue such as a title or name of an issue, a ticket number associated with the issue, how many people are assigned to the issue, how long the issue has been open, or any other suitable information. The issue data 306 can include text, icons, or other graphical objects that display information about the issue. For example the first card 304-1 includes an issue title (e.g., “Afterburner revision VI script”), a ticket number (e.g., JNA-33) and indication of the number of users associated with the issue.

The update summary 308 can include information about updates that have been made to an issue. In some cases, the update summary 308 can include an indication of the number of updates that have not been viewed by a user of the associated user account. For example, a first update summary 308-1 for the first card 304-1 includes an indication of the number of new updates (e.g., “2 new updates”) to the first issue. Similarly, a second update summary 308-2 for a second card 304-2 includes an indication of the number of new updates (e.g., “4 new updates”) to the second issue. In some cases, the update summaries 308 can include other details about updates made to a particular issue. The update summary can indicate which parts of the issue were updated, whether an update is associated with a particular user, when the update was made, or any other suitable information. For example, the update summary 308 can reference a particular user who made the update and/or a user who is responsible for responding to the update (e.g., approving the update). The update summaries 308 can include text, symbols, and/or any other suitable graphical object.

In some cases, the update summary 308 can be updated in response to a user viewing or otherwise interacting with an issue card 304, the issue, and/or a specific update. For example, if a user views/interacts with an update that is presented in the first update summary 308-1, a view flag for this update may be changed to indicate that the update was viewed. Accordingly, the system may update the issue summary 308-1 to indicate that there is only one new update. In some cases, viewing the issue card 304 may count as viewing an issue, which can trigger the view flag to be updated to reflect that the new update has been viewed. In other cases, the user may need to view the source content and/or otherwise interact with or acknowledge the new update in order to update the view flag and update the update summary 308.

The issue feed board 302 may include cards 304 for a subset of issues associated with a particular user. In some cases, the number of cards 304 may be greater than can fit within a display of the client device and the mobile application may allow a user to scroll to view additional cards 304. The cards 304 can be arranged in a variety of ways. In some cases, cards 304 with the more recent updates can be displayed higher in the list. Additionally or alternatively, the cards 304 can be displayed based on a priority associated with a corresponding issue. For example, cards associated with higher priority issues can be displayed higher in the list. In some cases, issues may include a response time for a user to respond to an update or set of updates. In these cases, the cards 304 may be arranged according to the response times, for example, cards with sooner response times can be displayed higher in the list.

The subset of cards 304 displayed in the issue feed board 302 may be selected based on a variety of factors associated with the corresponding issues. For example, it may be desirable to only display cards 304 for issues that are high priority and/or have an approaching deadline. This may help reduce the amount of cards 304 displayed in the issue feed board 302 such that the issue feed board 302 primarily contains higher priority items that need to be addressed by a user.

In some cases, the UI on the mobile application may include global tools, which are used to manage and/or perform various functions in the mobile application. For example, the mobile application can include a tool bar 312. In some cases, updates for a user and/or project may be displayed and/or accessible from multiple different points in a mobile application. For example, the tool bar 312 can include a notifications tool 314, which can indicate a number of new updates associated with a user account. Selecting the notifications tool 314 may cause the mobile application to display a notifications feed including a list of all updates associated with a particular user. In some cases, the notifications feed can include an indication of all new updates associated with a user, for example, updates to all the projects and/or issues associated with a particular user account. Selecting the notifications tool 314 may take the user out of a particular project feed and display a global feed.

In some cases, the global feed can be a multi-platform feed, which displays notifications related to issues and/or content items from various platforms such as an issue tracking system, a collaborative document system, a code base system, and so on, as described herein. In some cases, a feed (e.g., multi-platform feed) may provide a UI scheme and/or selection of issues, content items, etc. based on the application platform. For example, cards, issue summaries, and/or a selection of issues may be implemented in a first way for a mobile application and be implemented in a second way for a desktop application. In some cases, different selections of issues, content items, etc. may be displayed depending on whether a user is interacting with a mobile application or a desktop application.

FIG. 4A shows an example issue summary board 400 displayed in a graphical user interface of a mobile issue tracking application. The issue summary board 400 may be displayed in response to a user selecting a card from an issue feed board. For example, the issue summary board 400 may be displayed in response to a user selecting the first card 304-1 from the issue feed board 302. The issue summary board 400 can include a title 402 associated with the issue and display additional details associated with the issue. For example the issue summary board 400 may include a list of fields 404 that can be used to display and/or modify various properties of the issue. The list of fields 404 can include a priority field 405-1 which can allow one or more users to modify a priority associated with the issue, a reminders field 405-2 for setting various reminders, a field 405-3 for linking to other issues, a drawings/diagrams field 405-4, a comments field 405-5 and so on. The list of fields 404 can include any other suitable fields, which may be unique to a particular issue.

The issue summary board 400 may include one or more visual indicators 406 that indicate which portions of the issue have new updates. For example, the first card 304-1 provided an update summary 308-1 that indicated that there were two new updates to the issue. The issue summary board 400 may include a visual indicator 406 for each of these two updates. For example, a first visual indicator 406-1 can indicate that the priority field has a new update and a second visual indicator 406-2 can indicate that the comments field also has a new update. Accordingly, a user may be able to easily see which properties of the issue have new updates.

In some cases, the visual indicators 406 may be cleared in response to a user viewing the issue summary board 400. This can include updating a view flag that is associated with each new update to indicate that each of the updates has been viewed by that user. Updating the view flag may cause the visual indicators 406 to be updated in accordance with a view flag. For example if a view flag is changed to indicate that a user viewed a new update, the system may update the visual indicators in accordance with the view flag. In some cases, viewing content on a mobile or desktop application may be detected in real-time or as part of an event log by the CUS (e.g., CUS 118 of FIG. 1). As a result of an action received at the platform application and associated with a new update to the issue data, the value of the view flag is updated and stored. Because the update has been viewed by a particular user, the view flag state may be specific to that user. For example, the state of the view flag may not change for another user of the system that has not viewed the same update(s). Accordingly, each view flag can be user specific and configured to reflect the event history or detected view history of a particular user.

In other cases, the visual indicators 406 may not be cleared until a user interacts with the update and/or the field associated with an update. The system may not update a view flag until it receives a user input that is associated with a particular new update and/or the associated issue field. For example, the system may update a view flag associated with the update to the priority field in response to receiving a user input to the a first visual indicator 406-1 and/or the priority field. In some cases, updating a view flag may include changing a state of the view flag. Additionally, the system may update the view flag associated with the update to the comment field in response to receiving a user input to the second visual indicator 406-2 and/or the comment field. Accordingly, each update may be managed independently of other updates and a subset of the view flags for updates associated with an issue can be updated to clear new update indications while other view flags for updates associated with an issue may not be updated and the mobile application can continue to display an indication that the update is new (e.g., has not been viewed and/or interacted with). Additionally or alternatively, an update to a view flag can be user specific and an update to a view flag for an issue may be associated with a first user, while view flags associated with other users and corresponding to the same issue may not be updated.

FIG. 4B show an example issue summary board 410 displayed in a graphical user interface of a mobile issue tracking application. The issue summary board 410 may be displayed in response to a user selecting a card from an issue feed board. For example, the issue summary board 410 may be displayed in response to a user selecting the first card 304-1 from the issue feed board 302.

In some cases, the issue summary board 410 can include an update list including update indicators 412 indicating which fields and/or properties of the issue are associated with the new updates. In some cases, the update indicators may be displayed at a top of the issue summary board 410, so that a user can see what aspects of the issue include new updates. The update indicators 412 can be active elements that, when selected, cause the mobile application to display the updated field in the user interface. For example, in response to receiving an indication of a user interaction with a first update indicator 412-1, the mobile application may scroll to (or otherwise cause) the priority field to be displayed in the UI. In response to receiving an indication of a user interaction with a second update indicator 412-2, the mobile application may scroll to (or otherwise cause) the comments field to be displayed in the UI. In some cases, the system may update a corresponding view flag in response to a user interaction with an update indicator. The update indicators 412 may be implemented in addition to or as an alternative to the visual indicators 406 shown in FIG. 4A.

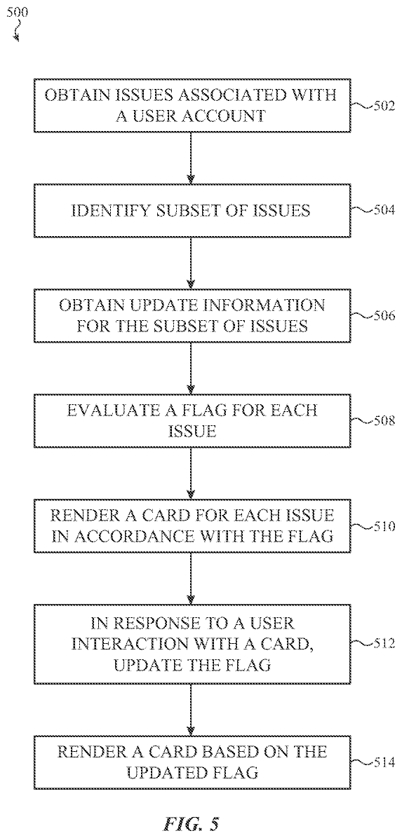

FIG. 5 shows an example process 500 for displaying updates on a mobile application for issues managed by an issue tracking system. The example process 500 can be performed by the systems described herein including the networked computer system 100.

At operation 502, the process 500 can include obtaining issues associated with a user account. A user of the system may login to a mobile application on their client device with a set of credentials that authenticates a user, defines a user role, and can be used to define permissions for a user. The user may use a user identification to perform the authentication procedure which may be accomplished using typical processes such as a single sign on operation. The user identification can be used by the system to retrieve issues associated with the user. For example, various issues managed by an issue tracking system may include information that associates a user identification with an issue. The mobile application can access the issue tracking system to identify and retrieve issues associated with a user.

At operation 504, the process 500 can include identifying a subset of issues for display on an issue summary feed. In some cases, the mobile application may retrieve a list of issues associated with a user from the issue management system and/or other data associated with a user and then determine a subset of issues from the issue list to display on the issue summary feed. The mobile application may retrieve and/or request additional issue data from the issue management system for the subset of issues that will be displayed in the issue summary feed. In other cases, the mobile application may query the issue management system to obtain a subset of all issues associated with the user identification. The query may include parameters for retrieving issues such as a priority of an issue, due date, time pending, issues awaiting input from the user, and so on. In some cases, the user may set parameters in the mobile application for which issues are obtained from the issue tracking system. For example, the user may set parameters that retrieve issues that have new updates, are due within a define time period, have a certain priority, require input from the user, and/or the like.

In some cases, operation 504 can include an event-driven system. The issue tracking system may receive a user input, interaction or other activity with an issue, issue data, a subset of issues, and so on. For example, a priority of a project may be updated by a user from moderate priority to high priority. This activity may result in an event notification or other type of message being sent to an event feed service (e.g., event feed service 110 shown in FIG. 1). The notification or message may include issue data or other information related to the issue and/or update. The event feed service may store the notifications and respective issue data.

At operation 506, the process 500 can include obtaining update information for issues of the subset of issues. In some cases, operation 506 can include querying an update service to obtain update information for each issue. The update service (e.g., CUS 118 shown in FIG. 1) may track when a new update(s) is made to an issue, which may be used to provide an update notification and/or display a new update summary as described herein. In some cases, the updated information may also come from an event feed service and/or issue tracking system. For example, the update service may track and store events in real-time and/or generate update information from user event logs.

The update service may also determine when to clear an update notification and/or update a new update summary that is displayed in the mobile application (e.g., update summary 308 or visual indicator 406). The update service may generate a view flag for each new update that is made. The view flag can be associated with a particular update and/or issue, and can be generated in response to a new update to an issue. The view flag can also be associated with a particular user, which may allow new updates to be managed on a user-by-user basis.

At operation 508, the process 500 can include evaluating view flags for each issue that has one or more updates. The view flag may include a first condition that indicates that a user has not viewed or otherwise interacted with an update and a second state that indicates that the user has viewed or otherwise interacted with the associated update. In response to determining a subset of issues for display on an issue feed board, the mobile application can query the update service to obtain update information. In some cases, update applications can manage the view flags associated with each issue and send an indication of view flags for each new update to the mobile application in response to the query. In other cases, the mobile application may manage the view flag variable and, in response to receiving update information for an issue, the mobile application can generate a view flag for new updates to an issue. In these cases, the mobile application may send updates to the update service that indicate whether a new issue has been viewed or otherwise interacted with and the update service can change a status of the new updates (e.g., to a viewed status), update a log, and/or otherwise indicate that the update is no longer new/unviewed.

At operation 510, the process 500 can include rendering a card for each issue in accordance with the view flag. Rendering the card can include obtaining issue data regarding the respective issue associated with the card. The issue data can be an example of the issue data described herein and include information such as a title of the issue, an issue identification, a priority of the issue, users associated with the issue, a creation date, a date of the most recent update, one or more deadlines, dependencies on other issues or actions, or other suitable information about the issue.

Rendering the card can also include generating an update summary. The update summary can be an example of the update summaries described herein and include an indication of a new update(s) associated with a particular issue. The update summary can be generated in response to update information being available for an issue from an issue service and a view flag indicating that the issue has not been viewed or otherwise interacted with.

Rendering the card can also include causing the mobile application to display the card on the issue feed board, as described herein. The card can include issue data such as a title of the issue and the update summary for the issue, as described herein.

In some cases, the feed service can generate cards using the issue data (e.g., issue data stored in response to an event such as change in the priority of an issue as discussed above) and/or update information associated with the issue. The feed service may query an update service (e.g., CUS 118) for update information. In other cases, the update information can be sent as part of a notification or message.

At operation 512, the process 500 can include updating a view flag in response to a user activity. For example, a user may view the new updates to an issue by selecting a card (e.g., using touch input or other input) and/or selecting an update summary displayed on the card. In some cases, the type of input to the client device can determine how to update the view flag. For example, specific types of user activity may cause the system to change a state/value of a view flag to indicate that an update was viewed. These types of activities can include selecting an issue card, causing the application to display issue information associated with updates on a display (e.g., indicating that the user actually viewed the updated content), selecting and viewing a portion of the issue associated with an update (e.g., on an update by update basis), and viewing an update to an issue on another device and/or application platform.

In some cases, certain types of activities may not cause the system to change a state/value of a view flag. These types of activities can include viewing anther card of the same issue on another board, viewing the card in a different content feed, viewing the project summary card (e.g., project summary card 204), viewing the issue summary but not actually viewing the updates (in some instances), and so on.

Additionally or alternatively, the mobile application may provide different ways for a user to interface with, acknowledge, and/or clear an update summary or update indication displayed in a UI. For example, when interacting with a client device that includes a touch interface, the user may select the card to view additional details associated with the issue and/or the specific fields of the issue that were updated, as described herein, such as in FIGS. 4A-4B. In some cases, certain actions such as a long press (press meeting a threshold time duration) can cause the view flag to be updated to indicate the updates have been viewed, without the user viewing additional details.

In some cases, an update may require an input action from a user, for example, an approval of a change to a field or a response to a question. The system may not update a view flag to indicate that an issue was viewed until the user enters a response, for example, approving the change to the field or responding to the question.

At operation 514, the process 500 can include rendering the cards and/or issue summaries based on an updated flag. For example, in response to selecting a card and approving an update to an issue, the system may re-render the card to update the update summary, which my reflect that the issue was viewed. In one example, if a card indicated that there were two new issues, and the user approved (viewed or otherwise interacted with) one of those issues, the system may change the update summary to indicate that there is only one new update associated with the issue. In some cases, an update to a card (e.g., re-rendering the card) may occur at a subsequent time and/or in response to a particular activity. For example, the card may be re-rendered in response to a user navigating back to a project feed. Additionally or alternatively, the card can be re-rendered in response to viewing the issue from another device, a different application and/or platform (e.g., desktop application), or other interface.

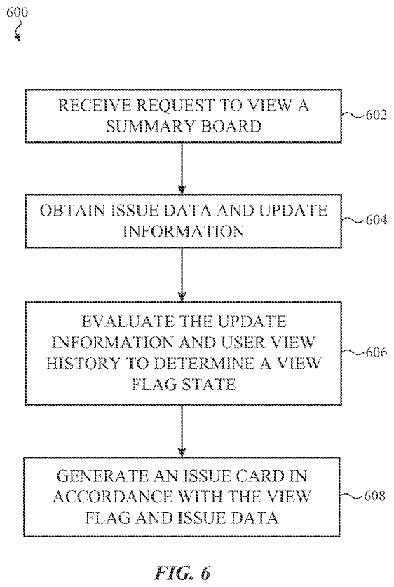

FIG. 6 shows an example process 600 for synchronizing updates across different application platforms of an issue tracking system. The process 600 may allow a user to view and/or respond to updates using a first application (e.g., mobile application running on a first client device) and those updates are carried over to other applications (e.g., a desktop application running a second client device). Accordingly, a user may use multiple different client devices and/or different application platforms and issue updates made on one platform and carried over to other application platforms. The process can be performed by the systems described herein including the networked computer system 100.

At operation 602, the process 600 can include receiving a request to view a summary board. In some cases, the request may come from a desktop application running on a client device. In other cases, the request may come from a mobile application running on a different client device.

At operation 604, the process 600 can include obtaining issue data and update information corresponding to the issue data. Operation 604 may be an example of operations 502 and/or 504 described with reference to FIG. 500. In some cases, the application may retrieve a list of issues associated with a user from the issue management system and/or other data associated with a user and then determine a subset of issues from the issue list to display on the issue summary feed. The application may retrieve and/or request additional issue data from the issue management system for the subset of issues that will be displayed in the issue summary feed. In other cases, the mobile application may query the issue management system to obtain a subset of all issues associated with the user identification. The query may include parameters for retrieving issues such as a priority of an issue, due date, time pending, issues awaiting input from the user, and so on. In some cases, the user may set parameters in the mobile application for which issues are obtained from the issue tracking system. For example, the user may set parameters that retrieve issues that have new updates, are due within a defined time period, have a certain priority, require input from the user, and/or the like.

In some cases, operation 604 can include querying an update service to obtain update information for each issue. Operation 604 can be an example of operation 506, described with reference to FIG. 5. The update service may track when a new update(s) is made to an issue, which may be used to provide an update notification and/or display a new update summary as described herein. The update service may also determine when to clear an update notification and/or update a new update summary that is displayed in the mobile application (e.g., update summary 308 or visual indicator 406). The update service may generate a view flag for each new update that is made. The view flag can be associated with a particular update and/or issue, and can be generated in response to a new update to an issue. The view flag can also be associated with a particular user, which may allow new updates to be managed on a user-by-user basis.

At operation 606, the process 600 can include evaluating the update information and user view history to determine a flag state. Operation 606 can be an example of operations 508 described with reference to FIG. 5. For example, if a user viewed a particular update using a mobile application, the mobile application may update a view history to indicate that the update was viewed by the user. The user view history may be managed by an update service that is accessible from each application and associates view histories for each update with a user account. If the user later views the issue using a different application, such as a desktop application, the desktop application may access the view history to determine a state of a view flag associated for each update associated with a particular issue.

At operation 608, the process 600 can include generating an issue card in accordance with the view flag and issue data. Operation 608 can be an example of operation 510, described with respect to FIG. 5. For example, an update to an issue may initially be displayed on a card (e.g., in an update summary) on a mobile application and viewed by the user in the mobile application. When a desktop application retrieves the issue data and renders a card for the issue, for example on an issue feed board generated by the desktop application, the card for the corresponding issue may be updated based on the view flag indicating that the issue was viewed by the user. Accordingly, the card generated by the desktop application may have an update summary that does not include the update that was previously viewed in the mobile application.

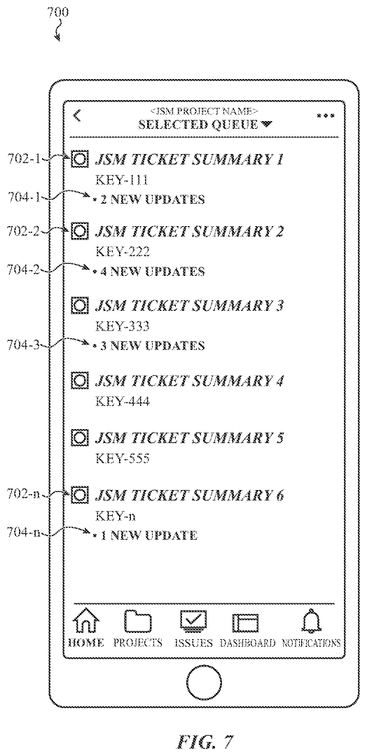

FIG. 7 shows an example issue service queue 700 displayed in a graphical user interface of a mobile issue tracking application. The issue service queue can render and display issue cards 702 corresponding to issues managed by an issue tracking system, as described herein. In some cases, the issue service queue may display cards that are associated with a ticket summary, which may be used to provide metrics for completed or pending issues. For example, an issue summary may include information about whether an issue was resolved, how long it took to resolve the issue, users assigned to the issue, or any other suitable information. The issue service queue 700 can organize and/or display issue cards 702 according to an urgency and/or order that the issues need to be addressed. The cards 702 can include issue summary information such as a title associated with the issue summary, an issue summary identification, and so on. The cards 702 can also include an update summary 704, as described herein. Accordingly, the system can provide update summaries 704 in the context of an issue summary or other content items managed by an issue tracking system.

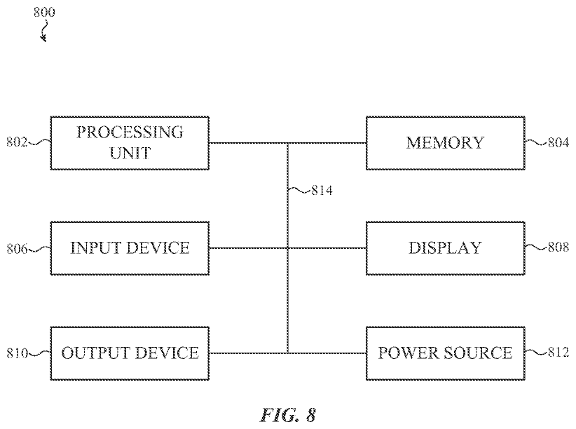

FIG. 8 shows a sample electrical block diagram of an electronic device 800 that may perform the operations described herein. The electronic device 800 may in some cases take the form of any of the electronic devices described with reference to FIGS. 1-7, including client devices, and/or servers or other computing devices associated with the collaboration system 100. The electronic device 800 can include one or more of a processing unit 802, a memory 804 or storage device, input devices 806, a display 808, output devices 810 and power source 812. In some cases, various implementations of the electronic device 800 may lack some or all of these components and/or include additional or alternative components.

The processing unit 802 can control some or all of the operations of the electronic device 800. The processing unit 802 can communicate, either directly or indirectly, with some or all of the components of the electronic device 800. For example, a system bus or other communication mechanism 814 can provide communication between the processing unit 802, the power source 812, the memory 804, the input device(s) 806, and the output device(s) 810.

The processing unit 802 can be implemented as any electronic device capable of processing, receiving, or transmitting data or instructions. For example, the processing unit 802 can be a microprocessor, a central processing unit (CPU), an application-specific integrated circuit (ASIC), a digital signal processor (DSP), or combinations of such devices. As described herein, the term “processing unit” is meant to encompass a single processor or processing unit, multiple processors, multiple processing units, or other suitably configured computing element or elements.

It should be noted that the components of the electronic device 800 can be controlled by multiple processing units. For example, select components of the electronic device 800 (e.g., an input device 806) may be controlled by a first processing unit and other components of the electronic device 800 (e.g., the display 808) may be controlled by a second processing unit, where the first and second processing units may or may not be in communication with each other.

The power source 812 can be implemented with any device capable of providing energy to the electronic device 800. For example, the power source 812 may be one or more batteries or rechargeable batteries. Additionally or alternatively, the power source 812 can be a power connector or power cord that connects the electronic device 800 to another power source, such as a wall outlet.

The memory 804 can store electronic data that can be used by the electronic device 800. For example, the memory 804 can store electronic data or content such as, for example, audio and video files, documents and applications, device settings and user preferences, timing signals, control signals, and data structures or databases. The memory 804 can be configured as any type of memory. By way of example only, the memory 804 can be implemented as random access memory, read-only memory, Flash memory, removable memory, other types of storage elements, or combinations of such devices.

In various embodiments, the display 808 provides a graphical output, for example associated with an operating system, user interface, and/or applications of the electronic device 800 (e.g., a chat user interface, an issue-tracking user interface, an issue-discovery user interface, etc.). In one embodiment, the display 808 includes one or more sensors and is configured as a touch-sensitive (e.g., single-touch, multi-touch) and/or force-sensitive display to receive inputs from a user. For example, the display 808 may be integrated with a touch sensor (e.g., a capacitive touch sensor) and/or a force sensor to provide a touch- and/or force-sensitive display. The display 808 is operably coupled to the processing unit 802 of the electronic device 800.

The display 808 can be implemented with any suitable technology, including, but not limited to, liquid crystal display (LCD) technology, light emitting diode (LED) technology, organic light-emitting display (OLED) technology, organic electroluminescence (OEL) technology, or another type of display technology. In some cases, the display 808 is positioned beneath and viewable through a cover that forms at least a portion of an enclosure of the electronic device 800.

In various embodiments, the input devices 806 may include any suitable components for detecting inputs. Examples of input devices 806 include light sensors, temperature sensors, audio sensors (e.g., microphones), optical or visual sensors (e.g., cameras, visible light sensors, or invisible light sensors), proximity sensors, touch sensors, force sensors, mechanical devices (e.g., crowns, switches, buttons, or keys), vibration sensors, orientation sensors, motion sensors (e.g., accelerometers or velocity sensors), location sensors (e.g., global positioning system (GPS) devices), thermal sensors, communication devices (e.g., wired or wireless communication devices), resistive sensors, magnetic sensors, electroactive polymers (EAPs), strain gauges, electrodes, and so on, or some combination thereof. Each input device 806 may be configured to detect one or more particular types of input and provide a signal (e.g., an input signal) corresponding to the detected input. The signal may be provided, for example, to the processing unit 802.

As discussed above, in some cases, the input device(s) 806 include a touch sensor (e.g., a capacitive touch sensor) integrated with the display 808 to provide a touch-sensitive display. Similarly, in some cases, the input device(s) 806 include a force sensor (e.g., a capacitive force sensor) integrated with the display 808 to provide a force-sensitive display.

The output devices 810 may include any suitable components for providing outputs. Examples of output devices 810 include light emitters, audio output devices (e.g., speakers), visual output devices (e.g., lights or displays), tactile output devices (e.g., haptic output devices), communication devices (e.g., wired or wireless communication devices), and so on, or some combination thereof. Each output device 810 may be configured to receive one or more signals (e.g., an output signal provided by the processing unit 802) and provide an output corresponding to the signal.

In some cases, input devices 806 and output devices 810 are implemented together as a single device. For example, an input/output device or port can transmit electronic signals via a communications network, such as a wireless and/or wired network connection. Examples of wireless and wired network connections include, but are not limited to, cellular, Wi-Fi, Bluetooth, IR, and Ethernet connections.

The processing unit 802 may be operably coupled to the input devices 806 and the output devices 810. The processing unit 802 may be adapted to exchange signals with the input devices 806 and the output devices 810. For example, the processing unit 802 may receive an input signal from an input device 806 that corresponds to an input detected by the input device 806. The processing unit 802 may interpret the received input signal to determine whether to provide and/or change one or more outputs in response to the input signal. The processing unit 802 may then send an output signal to one or more of the output devices 810, to provide and/or change outputs as appropriate.

As used herein, the phrase “at least one of” preceding a series of items, with the term “and” or “or” to separate any of the items, modifies the list as a whole, rather than each member of the list. The phrase “at least one of” does not require selection of at least one of each item listed; rather, the phrase allows a meaning that includes at a minimum one of any of the items, and/or at a minimum one of any combination of the items, and/or at a minimum one of each of the items. By way of example, the phrases “at least one of A, B, and C” or “at least one of A, B, or C” each refer to only A, only B, or only C; any combination of A, B, and C; and/or one or more of each of A, B, and C. Similarly, it may be appreciated that an order of elements presented for a conjunctive or disjunctive list provided herein should not be construed as limiting the disclosure to only that order provided.

One may appreciate that although many embodiments are disclosed above, that the operations and steps presented with respect to methods and techniques described herein are meant as exemplary and accordingly are not exhaustive. One may further appreciate that alternate step order or fewer or additional operations may be required or desired for particular embodiments.

Although the disclosure above is described in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the some embodiments of the invention, whether or not such embodiments are described and whether or not such features are presented as being a part of a described embodiment. Thus, the breadth and scope of the present invention should not be limited by any of the above-described exemplary embodiments but is instead defined by the claims herein presented.

In addition, it is understood that organizations and/or entities responsible for the access, aggregation, validation, analysis, disclosure, transfer, storage, or other use of private data such as described herein will preferably comply with published and industry-established privacy, data, and network security policies and practices. For example, it is understood that data and/or information obtained from remote or local data sources, only on informed consent of the subject of that data and/or information, should be accessed only for legitimate, agreed-upon, and reasonable uses.

Example computing resources or appliances that may be configured to perform the methods described herein include, but are not limited to: single or multi-core processors; single or multi-thread processors; purpose-configured co-processors (e.g., graphics processing units, motion processing units, sensor processing units, and the like); volatile or non-volatile memory; application-specific integrated circuits; field-programmable gate arrays; input/output devices and systems and components thereof (e.g., keyboards, mice, trackpads, generic human interface devices, video cameras, microphones, speakers, and the like); networking appliances and systems and components thereof (e.g., routers, switches, firewalls, packet shapers, content filters, network interface controllers or cards, access points, modems, and the like); embedded devices and systems and components thereof (e.g., system(s)-on-chip, Internet-of-Things devices, and the like); industrial control or automation devices and systems and components thereof (e.g., programmable logic controllers, programmable relays, supervisory control and data acquisition controllers, discrete controllers, and the like); vehicle or aeronautical control devices systems and components thereof (e.g., navigation devices, safety devices or controllers, security devices, and the like); corporate or business infrastructure devices or appliances (e.g., private branch exchange devices, voice-over internet protocol hosts and controllers, end-user terminals, and the like); personal electronic devices and systems and components thereof (e.g., cellular phones, tablet computers, desktop computers, laptop computers, wearable devices); personal electronic devices and accessories thereof (e.g., peripheral input devices, wearable devices, implantable devices, medical devices and so on); and so on. It may be appreciated that the foregoing examples are not exhaustive.

The foregoing examples and description of instances of purpose-configured software, whether accessible via API as a request-response service, an event-driven service, or whether configured as a self-contained data processing service are understood as not exhaustive. In other words, a person of skill in the art may appreciate that the various functions and operations of a system such as described herein can be implemented in a number of suitable ways, developed for leveraging any number of suitable libraries, frameworks, first or third-party APIs, local or remote databases (whether relational, NoSQL, or other architectures, or a combination thereof), programming languages, software design techniques (e.g., procedural, asynchronous, event-driven, and so on or any combination thereof), and so on. The various functions described herein can be implemented in the same manner (as one example, leveraging a common language and/or design), or in different ways. In many embodiments, functions of a system described herein are implemented as discrete microservices, which may be containerized or executed/instantiated for leveraging a discrete virtual machine, that are only responsive to authenticated API requests from other microservices of the same system. Similarly, each microservice may be configured to provide data output and receive data input across an encrypted data channel. In some cases, each microservice may be configured to store its own data in a dedicated encrypted database; in others, microservices can store encrypted data in a common database; whether such data is stored in tables shared by multiple microservices or whether microservices may leverage independent and separate tables/schemas can vary from embodiment to embodiment. As a result of these described and other equivalent architectures, it may be appreciated that a system such as described herein can be implemented in a number of suitable ways. For simplicity of description, many embodiments that follow are described in reference an implementation in which discrete functions of the system are implemented as discrete microservices. It is appreciated that this is merely one possible implementation.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of the specific embodiments described herein are presented for purposes of illustration and description. They are not targeted to be exhaustive or to limit the embodiments to the precise forms disclosed. It will be apparent to one of ordinary skill in the art that many modifications and variations are possible in view of the above teachings.

What is claimed is:

1. A computer-implemented method for synchronizing update notifications for feed items of an issue tracking system, the method comprising:
in response to a request to view an issue summary board on a mobile device:
obtaining a user identification associated with the request; and
obtaining a list of issues associated with the user identification;
identifying a subset of issues for display on the issue summary board;
for each issue of the subset of issues, querying an update service for update information;
rendering a set of cards, each card associated with a respective issue of the subset of issues, the rendering the set of cards comprising, for each card:
obtaining issue data regarding the respective issue associated with a card;
in accordance with the update information being available for the respective issue and a view flag indicating that an issue has not been viewed, generate an update summary; and
causing display of the card on the issue summary board, the card comprising at least a portion of the issue data and the update summary;
in response to a user selecting a particular card of a list of cards displayed on the issue summary board:
causing the display of the issue data for the respective issue associated with the particular card; and
modifying the view flag to indicate that the update summary for a particular issue has been viewed; and
in response to a request to view the particular issue subsequent to modifying the view flag:
causing the display of the issue data of the particular issue within the card; and
updating the display of the update summary associated with the particular issue in accordance with the view flag.

2. The method of claim 1, further comprising:
prior to receiving the request to view an issue summary board on a mobile device, receiving a request to view a notification feed on the mobile device;
in response to receiving the request to view the notification feed:
causing the notification feed to display a list of new updates, the list of new updates comprising updates to the respective issue associated with the particular card; and
minting a current state of the view flag for the respective issue.

3. The method of claim 1, wherein:
the update information for the particular issue comprises multiple updates;
the update summary for the particular issue comprises an indication of the multiple updates; and
causing the display of the issue data for the respective issue comprises displaying an indication regarding a portion of the issue data that corresponds to each of the multiple updates.

4. The method of claim 3, further comprising receiving an indication of a user interaction with a particular update of the multiple updates, wherein:
modifying the view flag comprises indicating that the particular update has been viewed and other updates of the multiple updates have not been viewed; and
updating the display of the update summary in accordance with the view flag comprises removing an indication of the particular update and preserving indications of other updates of the multiple updates.

5. The method of claim 1, wherein:
the issue data comprises one or more issue categories; and
the computer-implemented method further comprises:
determining, from the update information, a category of the one or more categories comprising an update; and
in response to the user selecting a particular card of the list of cards displayed on the issue summary board, causing display of an update indication in association with the category.

6. The method of claim 5, further comprising:
receiving an indication of a user interaction with the category; and
in response to receiving the indication of the user interaction, modifying the view flag to indicate that the update has been viewed.

7. The method of claim 6, wherein the user interaction comprises an input to the mobile device, the input comprising at least one of a selection of the category or a selection of an update indication.

8. The method of claim 1, wherein:
the issue data comprises at least one of a status of the issue, a priority of the issue, activity associated with the issue, and comments associated with the issue; and
the update information comprises a change to the issue data.

9. The method of claim 1, wherein the issue data is obtained from the issue tracking system and further comprising, in response to modifying the view flag to indicate that the update summary for the particular issue has been viewed, sending an indication of the modification to the view flag to the issue tracking system.

10. A computer-implemented method for synchronizing update notifications for feed items of an issue tracking system, the method comprising:
in response to a request to view an issue summary board on a mobile device:
obtaining a user identification associated with the request; and
obtaining a list of issues associated with the user identification;
identifying a subset of issues for display on the issue summary board;
for each issue of the subset of issues, querying an update service for update information;
rendering a set of cards, each card associated with a respective issue of the subset of issues, the rendering the set of cards comprising, for each card:
obtaining issue data regarding the respective issue associated with the card;
in accordance with update information being available for the respective issue and a view flag indicating that the issue has not been viewed, generate an update summary; and
causing display of the card on the issue summary board, the card comprising at least a portion of the issue data and the update summary;
in response to a user selecting a particular card of list of cards displayed on the issue summary board:
causing the display of the issue data for the respective issue associated with the particular card, the issue data comprising an indication for each new update associated with an issue corresponding to the card;
in response to a user selecting an update, modifying a view flag corresponding to the selected update to indicate that the update for the for the issue has been viewed; and
in response to a request to view the particular care subsequent to modifying the view flag, updating the display of the update summary associated with the particular issue in accordance with the view flag.

11. The method of claim 10, wherein,
the update is a first update;
the view flag is a first view flag;
the issue associated with the particular card comprises a second update and a second view flag corresponding to the second update; and
the display of the update summary is further updated in accordance with the second view flag.

12. The method of claim 11, wherein:
in response to a user selecting a particular card of list of cards displayed on the issue summary board, the second view flag indicates that the second update was not viewed by the user.

13. The method of claim 11, further comprising
in response to a user selecting the second update, modifying the second view flag to indicate that the second update for the for the issue has been viewed; and
in response to a request to view the particular care subsequent to modifying the second view flag, updating the display of the update summary associated with the particular issue in accordance with the first and second view flags.

14. The method of claim 10, wherein selecting the update comprises at least one of a user input to a summary for the update, clearing a notification associated with the update, viewing a portion of the issue data corresponding to the update, modifying issue data associated with the update, or a combination thereof.

15. The method of claim 10, wherein:
the indication for each new update associated with an issue comprises a link that when selected causes the mobile device to display a portion of the issue data corresponding to the update; and
in response to the user selecting the link, modifying the view flag corresponding to the selected update to indicate that the update for the for the issue has been viewed.

16. A computer-implemented method for synchronizing update notifications for feed items of an issue tracking system, the method comprising:
in response to a request to view a first issue summary board on a mobile device:
obtaining a user identification associated with the request; and
obtaining a list of issues associated with the user identification;
identifying a subset of issues for display on the first issue summary board;
for each issue of the subset of issues, querying an update service for update information;
rendering a first set of cards, each card associated with a respective issue of the subset of issues, the rendering the set of cards comprising, for each card:
obtaining issue data regarding the respective issue associated with a card;
in accordance with the update information being available for the respective issue and a view flag indicating that an issue has not been viewed, generate an update summary; and
causing display of the card on the first issue summary board, the card comprising at least a portion of the issue data and the update summary;
in response to a user selecting a particular card of a list of cards displayed on the issue summary board modifying the view flag to indicate that the update summary for a particular issue has been viewed; and
in response to a request to view a second issue summary board associated with the user account on a desktop device subsequent to modifying the view flag:
causing the display of a second set of cards on the second issue summary board, the second set of cards comprising the particular card; and
updating the display of the update summary associated with the particular issue in accordance with the view flag.

17. The method of claim 16, further comprising:
in response to the user selecting the particular card, causing the mobile device to display the issue data for the respective issue associated with the particular card, the issue data comprising an indication for each new update associated with an issue.

18. The method of claim 17, further comprising:
receiving a selection of the indication for a new update associated with the issue; and
in response to the selection of the indication, modifying the view flag to indicate that the update summary for a particular issue has been viewed.

19. The method of claim 18, wherein the selection of the indication comprises a touch input to the mobile device received in the region of a touch interface displaying the new update.

20. The method of claim 16, wherein:
the issue data comprises at least one of a status of the issue, a priority of the issue, activity associated with the issue, and comments associated with the issue; and
the update information comprises a change to the issue data.
